(19) United States
(12) Patent Application Publication
(10) Pub. No.: US 2004/0230806 A1
(43) Pub. Date: Nov. 18, 2004

(54) Digital content control including digital rights management (DRM) through dynamic instrumentation

(75) Inventor: Michael G. Lisanke, Boynton Beach, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, Armonk, NY

(21) Appl. No.: 10/437,692

(22) Filed: May 14, 2003

(51) Int. Cl. H04K 1/00

(52) U.S. Cl. 713/182

(57) ABSTRACT

The present invention, according to a preferred embodiment, provides an efficient and easy-to-implement method to use existing DRM (Digital Rights Management) systems with existing media players. The present invention separates the enforcement of digital rights independent of the content-rendering software. Unlike many of the prior art systems, the present invention works with any non-DRM player. In one embodiment, the present invention enforces behavior restrictions on an application on an information processing system, which includes loading a dynamic instrumentation (DI) codemonitor. An entry point for an application is retrieved by inserting an instrumentation point thereinto. The instrumentation point is inserted in accordance with the entry point, wherein the instrumentation point causes a branch into the DI code monitor when executed. Depending on the application with the instrumentation point therein, the DI code monitor blocks a request made by the application code. In one embodiment the blocking of a request is made in accordance with a DRM system running.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS-REFERENCE TO RELATED APPLICATIONS

Not Applicable.

### BACKGROUND OF THE INVENTION

1. Field of the Invention

The invention disclosed broadly relates to the field of electronic commerce and more particularly to a system and related tools for the control of digital content and the use of digital rights management (DRM) of digital content, such as print media, films, games, and music over global communications networks and computer readable medium, such as DVDs and CDs.

2. Description of Related Art

The use of global distribution systems, such as the Internet, for distribution of digital assets, such as music, film, computer programs, pictures, games and other digital content, continues to grow. At the same time owners and publishers of valuable digital content have been slow to embrace the use of the Internet for distribution of digital assets for several reasons. One reason is that the owners are afraid of unauthorized copying or pirating of digital content. The electronic delivery of digital content removes several barriers to pirating. One barrier that is removed with electronic distribution is the requirement of the tangible recordable medium itself (e.g., diskettes or CD ROMs or DVDs.). It costs money to copy digital content on to tangible media, albeit, in many cases less than a dollar for a blank tape or recordable CD or DVDs. However, in the case of electronic distribution, the tangible medium is no longer needed. The cost of the tangible medium is not a factor because the content is distributed electronically. A second barrier is the format of the content itself, i.e. the content is stored in an analog format versus a digital format. The content is stored in an analog format, (for example, a printed picture), and when reproduced by photocopying, the copy is of lesser quality than the original. Each subsequent copy of a copy, sometimes called a generation, is of lesser quality than that of the original. This degradation in quality is not present when a picture is stored digitally. Each copy, and every generation of copies, is as clear and crisp as the original. The aggregate effect of perfect digital copies combined with the very low cost to distribute content electronically and to distribute content widely over the Internet makes it relatively easy to pirate and distribute unauthorized copies. With a couple of keystrokes, a pirate can send hundreds, or even thousands, of perfect copies of digital content over the Internet.

Although the distribution of digital content is protected by copyright laws, the policing of the Web and catching law-breakers is very difficult. Digital Rights Management (DRM) technology focuses on making it difficult, if not practically impossible, to steal digital content. A number of companies are providing assorted DRM products based on a variety of approaches and technologies. DRM products are turnkey packages that include everything needed for the operation, for example, server software, specialized client applications and user plug-ins for web browsers, and media players such as Apple QuickTime and Microsoft Media Player. Available DRM technologies include Electronic Media Management System (EMMS) from IBM, A2B from AT&T, Liquid Audio Pro from Liquid Audio Pro Corp., City Music Network from Audio Soft, InterTrust DRM, ContentGuard, EMediator DRM, from MediaDNA, Vyou.com and many others.

DRM systems, although useful, may require specific DRM client software designed to be integral to the DRM system for which it renders content. The DRM client software includes customized media players and/or specialized plug-ins. The DRM client software self-enforces the restrictions, i.e. digital rights placed on the content's use, by the owner and/or provider of the content.

The use of specialized client DRM software is problematic. Every time a web browser or media player is updated, the attendant DRM provider must update their specialized plug-in or DRM client system as well. Accordingly, a need exists for a method and system to allow providers of DRM systems to protect digital content without the need to install specific DRM client players and plug-ins to render the digital content.

Typically, the developers of a DRM system seek to maximize the availability of DRM client software capable of rendering the DRM content, and thereby maximizing the pervasiveness of the DRM content. The drawback to a DRM system providing a unique DRM client player that enforces the digital rights of the content provider, is that it restricts the software development model, and limits the media types (book, voice, music, video, html, live conferencing) of the content it handles. Often multiple business entities may wish to cooperate in providing software modules for the rendering of content (e.g. encode/decode (codec) library providers work with client “player” developers to provide a pervasive content data-type). The provider of DRM systems must often make choices on which media players and file formats to support. Content owners prepare their digital content for electronic distribution through a process known as encoding. Encoding involves taking the content, digitizing it if the content is presented in an analog format, and compressing it. The process of compressing allows the digital content to be transferred over networks and stored on a recordable medium more efficiently because the amount of data transmitted or stored is reduced. The sheer number of file types and players makes it difficult to support all the different formats. A specific client player must be used to render content prepared for a specific codec. For example, Macromedia encoded content is different from the content for Apple QuickTime, which is different from the content for Microsoft's Media Manager. Therefore, it is problematic to support a DRM client player that spans across a variety of players and formats without tremendous expense.

In addition, the media type of the content often changes the nature of the player that renders it, thus making a single client player to render all media types untenable, and the development of the DRM client software, with the multiple players it requires, more costly. In fact, the most commonly used client players of a specific content type are the non-DRM players of the content's media-type; the problem being that these non-DRM players do not enforce the digital rights of the content providers. Faced with this challenge, the providers of DRM systems must limit which players and file formats they support. Many times, various content owners and/or content providers of digital content embrace different DRM solutions. An artist of record “Company A” may use DRM systems from “Company Y”, and an artist of a film company may use a DRM system from “Company Z.” The user is forced to download two different DRM client modules to render the digital content from each artist. Accordingly, a need exists for a method and system to enable providers of DRM systems to support a wide variety of players and file formats and encoders, and to separate the use of specific DRM client software and plug-ins from the DRM system.

### SUMMARY OF THE INVENTION

According to a preferred embodiment of the present invention, a system computer readable medium and method for DRM (Digital Rights Management) enforcement mechanisms is separated from the development of content codec and rendering software. The present invention, according to a preferred embodiment, overcomes problems with the prior art by providing an efficient and easy-to-implement method to use existing DRM systems with existing media players. The present invention solves the problems with the prior art DRM systems by separating the enforcement of digital rights independent of the content-rendering software. Unlike many of the prior art system, the present invention works with any non-DRM player. The present invention blocks user actions and behaviors whenever the non-DRM player allows for the unencrypted (“in-the-clear”) rendering of the DRM content to be stored, printed, cut/copy-pasted, and more, beyond the restrictions placed by the content's provider. The term “DRM content” refers to content which is protected by a DRM system. DRM content is in contrast to content, which is not associated with a DRM system.

The present invention provides a mechanism to dynamically install and control the operation of all applications handling DRM content, and those applications which may attempt to access this content via inter-process OS mechanisms. The operation of standard application functions, such as “Print”, “Cut/Copy-Paste”, “Save/Save-As”, is selectively blocked (as determined by the content's digital rights) while the application is handling the DRM content. In addition, the operations of non-player applications that would attempt to use inter-process OS mechanisms to transfer copies of the rendered data from the application(s) handling the content is selectively blocked. Development of a DRM-enabled client “player” is no longer required, as content for a specific media and coding type is rendered on any available non-DRM player compatible with this content. In addition, business relationships are constructed where those parties developing software to render a specific content is unaware (or unconcerned) with the mechanisms that protect the content that they are handling.

In one embodiment, the present invention uses a three-fold approach. First, the end-user operating systems (OSs) provide mechanisms to extend an application's code-base at run-time (commonly referred to as dynamic-linking). Secondly, these OSs also have well documented methods for injecting dynamic link libraries into an application code-base using inter-process OS mechanisms. This process is sometimes referred to as dynamic-instrumentation as further defined below. Third, once an application is dynamically instrumented (DI), its operation is scripted (controlled) through inter-process communications mechanisms. In the present invention this is referred to DI code monitoring.

In another embodiment, the present invention uses the DI code monitor to install a front-end dialog to file “OpenAs” and “SaveAs” dialogs, extending the applications access to non-local files accessible via a client-server interface. In this embodiment, the present invention acts to installs extended behavior to applications written prior to an interface being available, and/or integrates this previously written application with a newer released product offering.

In one embodiment, the present invention enforces behavior restrictions on an application on an information processing system. The method includes loading a dynamic instrumentation (DI) code module. An entry point for an application is retrieved by inserting an instrumentation point thereinto. The instrumentation point is inserted in accordance with the entry point, wherein the instrumentation point causes a branch into the DI code monitor when executed. Depending on the application with the instrumentation point therein, the DI code monitor blocks a request made by the application code. In one embodiment, the blocking of a request is made in accordance with a running DRM system.

In another embodiment, the present invention uses the DI code monitor to block unauthorized access to certain protected files, such as an address book in an e-mail program (for example: Microsoft's Outlook Address book). In this embodiment, the present invention acts as a virus blocker.

In yet another embodiment, the present invention uses the DI code monitor to safely handle data for a content authoring program. In this embodiment, the DI code monitor makes sure that all file handles and buffers to a given data file is closed, even if the authoring tools hangs or improperly closes the file. This ensures that the data is not lost due to application crashes.

### BRIEF DESCRIPTION OF THE DRAWINGS

The subject matter, which is regarded as the invention, is particularly pointed out and distinctly claimed in the claims at the conclusion of the specification. The foregoing, other features, and also the advantages of the invention will be apparent from the following detailed description taken in conjunction with the accompanying drawings. Additionally, the left-most digit of a reference number identifies the drawing in which the reference number first appears.

FIG. 1 is a high-level block diagram of a multiple client server network.

FIG. 2 is a block diagram of a client computer system of FIG. 1, useful for implementing the present invention.

FIG. 3 is a block diagram of dynamic instrumentation as used in the present invention.

FIG. 4 is a block diagram of applications with instrumentation points and/or window hooks back to the dynamic instrumentation (DI) code monitor, according to the present invention

FIG. 5 is a block diagram of alternate embodiment of the dynamic instrumentation code with instrumentation points and/or window hooks in a windows graphics display interface (GDI) application, according to the present invention.

FIG. 6 is a block diagram of an alternate embodiment of the dynamic instrumentation code for windows messaging interception of an application, according to the present invention.

FIG. 7 is a flow diagram of an embodiment for initializing the dynamic instrumentation (DI) code monitor according to the present invention.

FIGS. 8 and 9 is a flow diagram of an embodiment of the dynamic instrumentation (DI) code monitor for handling branches from an application being dynamically instrumented in FIGS. 4 and 5.

FIG. 10 is a dialog box notifying a user that their attempted action or behavior exceeds the rights in the content, according to the present invention.

FIG. 11 is a dialog box showing an optional property of a DRM content file according to the present invention.

FIG. 12 is a block diagram of the dynamic instrumentation code with instrumentation points and/or windows hooks for file monitoring, according to the present invention.

### DESCRIPTION OF THE PREFERRED EMBODIMENTS

Terminology

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims, and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

References throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover, these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

The term “JUMP” refers to any conditional/unconditional branch in program execution, including interrupt, jump, call, and/or any other branch mechanism inherent in the target processor environment.

The term “dynamic instrumentation” refers to technique; typically to splicing dynamically code sequences into specific points of an operating system kernel or application code without the need to alter the source code of the operating system kernel or application code being instrumented. The splicing overwrites the machine code instructions at an instrumentation point with a jump to the patch code. Dynamically splicing is commonly used to monitor the performance of an operating system or the application program of a person interacting with a computer system. Although the present invention discusses implementations in the Microsoft Windows environment, other operating systems such as Unix, Solaris, Linux, and Apple OS, support dynamic instrumentation as well.

The term “GDI” or “Windows GDI” refers to the system by which graphics are displayed in Microsoft Windows. The application in use sends GDI the parameters for the image to be represented. GDI produces the image by sending commands to the monitor, printer, or other output device. Newer versions of Windows also have the DirectDraw interface, adding a faster mechanism for displaying games, full-motion video and 3-D objects. When the CPU is not busy, GDI updates the video display.

Exemplary Hardware Implementations

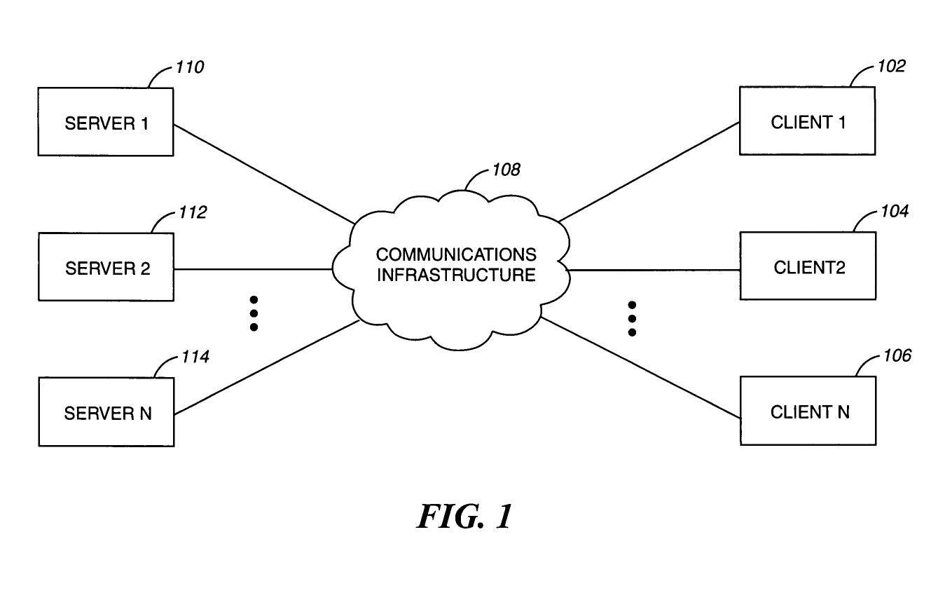

Turning now to FIG. 1; shown is a high-level block diagram of a multiple client server network. A plurality of client systems 102, 104 and 106 and connected through communication infrastructure 108 such as the Internet, word-wide web, WAN, LAN, wired, wireless, broadcast and other telecommunication infrastructures. Servers 110, 112, and 114 are a plurality. In one embodiment, the servers serve digital content, such as files, programs, videos, games, and music in any format, which is rendered by one or more client systems. The implementation of multiple client-server architecture is well understood to those of average skill in the art.

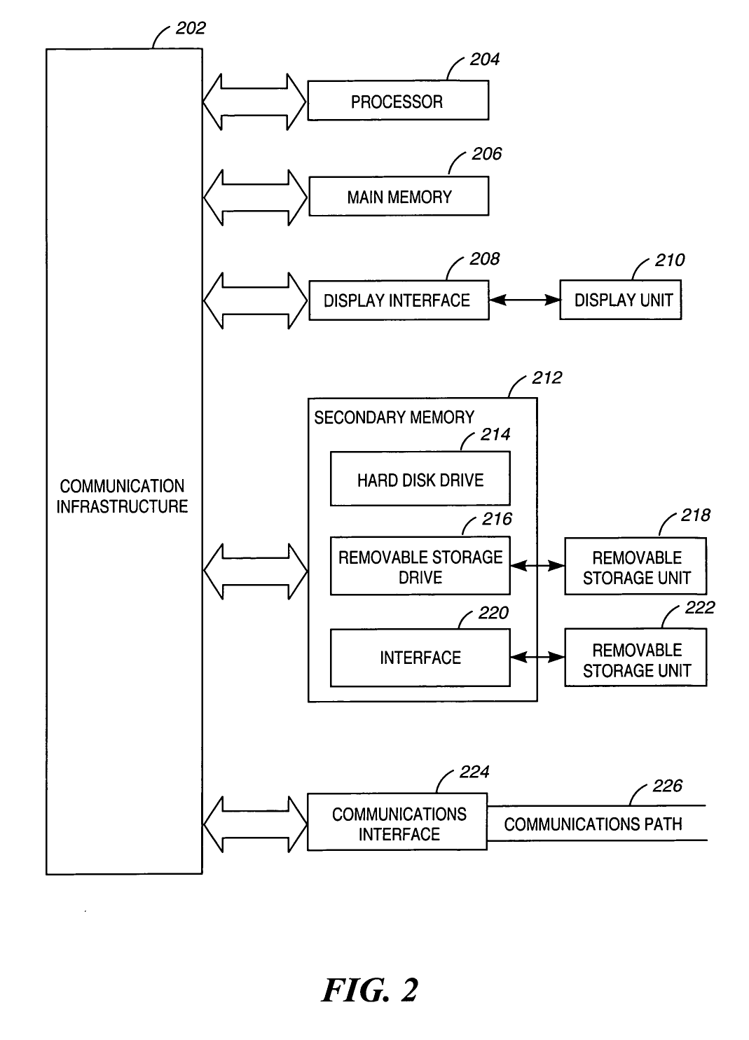

FIG. 2 is a block diagram of a client computer system of FIG. 1, useful for implementing the present invention. The present invention can be realized in hardware, software, or a combination of hardware and software in computer 102-106 of FIG. 1. A system according to a preferred embodiment of the present invention can be realized in a centralized fashion in one computer system, or in a distributed fashion where different elements are spread across several interconnected computer systems. Any kind of computer system —or other apparatus adapted for carrying out the methods described herein —is suited. A typical combination of hardware and software could be a general-purpose computer system with a computer program that, when being loaded and executed, controls the computer system such that it carries out the methods described herein.

An embodiment of the present invention can also be embedded in a computer program product (in computer 102 through 106), which comprises all the features enabling the implementation of the methods described herein, and which, when loaded in a computer system,—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form. A computer system may include, inter alia, one or more computers and at least a computer readable medium, allowing a computer system to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium, such as a network link and/or a network interface, including a wired network or a wireless network, that allow a computer system to read such computer readable information.

FIG. 2 is a block diagram of a computer system useful for implementing an embodiment of the present invention. The computer system of FIG. 2 is a more detailed representation of the computer 104 or the computer system of database 106. The computer system of FIG. 2 includes one or more processors, such as processor 204. The processor 204 is connected to a communication infrastructure 202 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 208 that forwards graphics, text, and other data from the communication infrastructure 202 (or from a frame buffer not shown) for display on the display unit 210. The computer system also includes a main memory 206, preferably random access memory (RAM), and may also include a secondary memory 212. The secondary memory 212 may include, for example, a hard disk drive 214 and/or a removable storage drive 216, representing a floppy disk drive, a magnetic tape drive, an optical disk drive, etc. The removable storage drive 216 reads from and/or writes to a removable storage unit 218 in a manner well known to those having ordinary skill in the art. Removable storage unit 218 represents, for example, a floppy disk, magnetic tape, optical disk, etc. which is read by and written to by removable storage drive 216. As will be appreciated, the removable storage unit 218 includes a computer usable storage medium having stored therein computer software and/or data.

In alternative embodiments, the secondary memory 212 may include other similar means for allowing computer programs or other instructions to be loaded into the computer system. Such means may include, for example, a removable storage unit 222 and an interface 220. Examples of such may include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to the computer system.

The computer system may also include a communications interface 224. Communications interface 224 allows software and data to be transferred between the computer system and external devices. Examples of communications interface 224 may include a modem, a network interface (such as an Ethernet card), a communications port, a PCMCIA slot and card, etc. Software and data transferred via communications interface 224 are in the form of signals which may be, for example, electronic, electromagnetic, optical, or other signals capable of being received by communications interface 224. These signals are provided to communications interface 224 via a communications path (i.e., channel 226). This channel 226 carries signals, and may be implemented using wire or cable, fiber optics, a phone line, a cellular phone link, an RF link, and/or other communications channels.

In this document, the terms “computer program medium,” “computer usable medium,” and “computer readable medium” are generally used to refer to media such as the main memory 206 and the secondary memory 212, removable storage drive 216, a hard disk installed in the hard disk drive 214, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. For example, it is useful for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 206 and/or secondary memory 212. Computer programs may also be received via communications interface 224. Such computer programs, when executed, enable the computer system to perform the features of the present invention as discussed herein. In particular, the computer programs, when executed, enable the processor 204 to perform the features of the computer system. Accordingly, such computer programs represent controllers of the computer system.

Dynamic Instrumentation

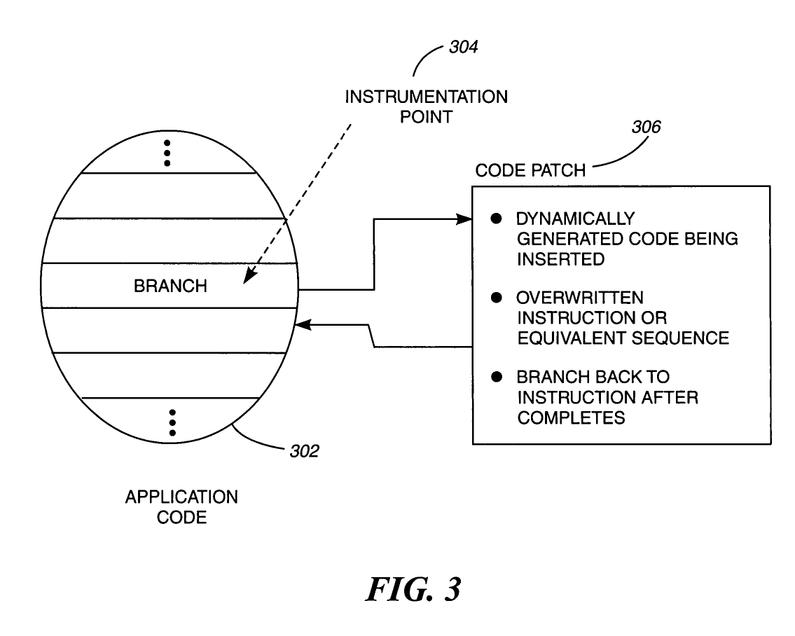

FIG. 3 is a block diagram of dynamic instrumentation as used in the present invention. A section of application code, such as a DLL (dynamic link library) 302, has an instrumentation point 304. The address of the instrumentation point 304 is derived in a variety of ways as known by those of average skill in the dynamic instrumentation art, depending on such things as the type of OS being used and the type of application (e.g. DLL or exe) being instrumented. One way the instrumentation point 302 is derived is by getting the starting point or header of the application 302. A second way to derive the instrumentation point 304 is to use what is known as an Import Address Table (IAT), which is built by the OS when the module gets loaded. A third way to derive the instrumentation point 304 is to use windows hooking to tell if the application has a message queue from the OS to the OS message. Once the instrumentation point 304 is inserted into the target application code, a branch to a code patch 306 occurs. The instrumentation of OS API that provide access to kernel objects (files, sockets, and other inter-process communication (IPC) mechanisms), or through cooperation with kernel drivers, which monitor this action.

In another embodiment, once the instrumentation point 304 is a call to another process, DLL or application such as through an API (application programming interface). During the instrumentation in this embodiment, the application being called just returns to the application code 302. Alternatively, the called application blocks the call by not returning properly or through stack manipulation in aborting the process being called. Both of these examples in this instrumentation example are used to control what happens when the application code 302 calls another program or process or DLL and the called application is handled differently.

Once the code patch executes, the process continues in the original application. It is important to note that the use of dynamic instrumentation makes it possible to intercept actions in the target application 302 without the use of source code or API's (application programming interface) provided by the application code owner.

The code patch in this present invention is called the dynamic instrumentation monitor code, or DI code monitor 406. The DI Code Monitor 406 is inserted in the application code 302 at instrumentation point 304. The DI Code Monitor 406 overwrites or executes in lieu of the application code 302. When the DI Code Monitor 406 completes, it will typically return to the application code 302 after the instrumentation point 304.

The DI Code Monitor 406 as is discussed in further detail below performs a variety of functions, such as intercepting messages, affecting the application code 302 by dismissing menus such as “Copy”, “Save As” and “Print”, changing the destination of messages from the application code 302 and more.

It is important to note that the instrumentation point for an application occurs in its process virtual memory (and no other). All code instrumentation must be done on a per process basis. The diagrams showing code patches are distinct processes (with their own virtual memory space). Patching code in an application to instantiate the DI code monitor is done repeatedly for all processes that need file system APIs monitored.

DI Code Monitor 406 Instrumentation Directly to an Application

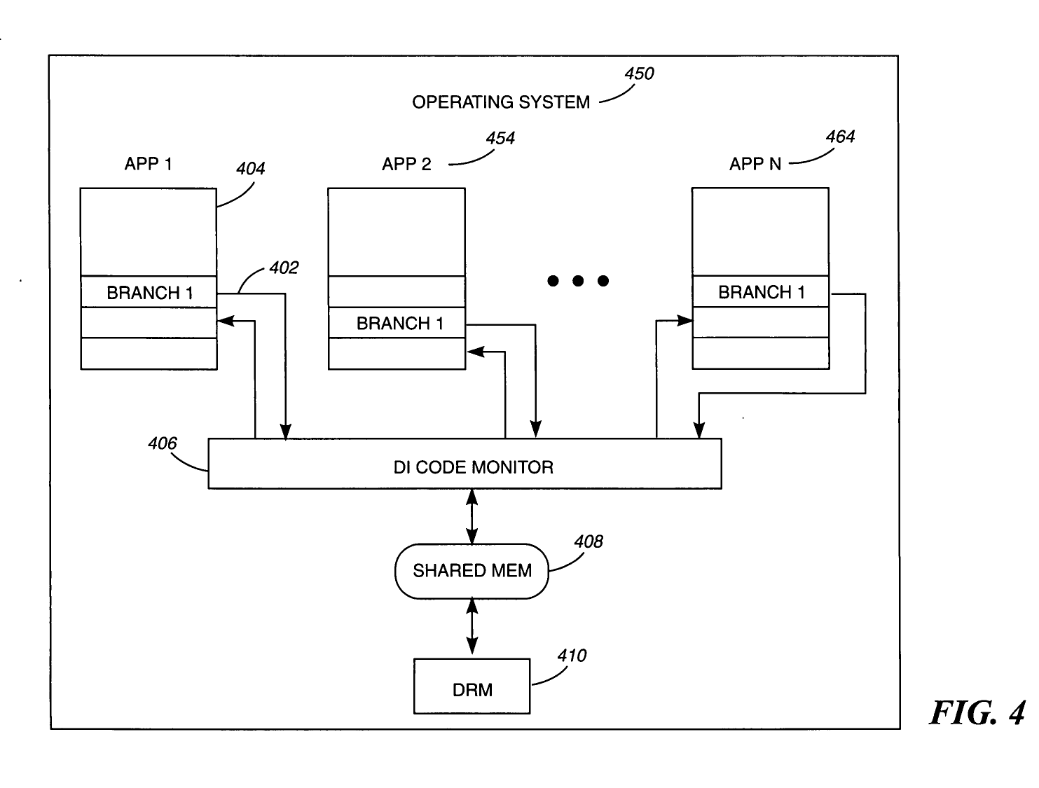

Turning now to FIG. 4, shown is a block diagram of applications with instrumentation points and/or window hooks back to the dynamic instrumentation (DI) code monitor, according to the present invention. Shown is an OS 450 with a plurality of application code 404, 454, and 464 each running under the OS 450. The application code 404, 454, and 464 represents any application code typically used to render or view digital content, such as a web browser, including Microsoft Internet Explorer, Netscape Navigator, Mozilla, and others, a portable document viewer such as Adobe Acrobat reader, a media player such as Apple Quicktime, Real Networks Real Player and Microsoft Media Player, office productivity packages such as those available from Apple, IBM, Microsoft, Sun and Corel, and any other application for rendering content that may be available as part of an OS or shipped separately. As described above in FIG. 3, inserted in the application code 404 is an instrumentation point 402 for branching to the DI Code Monitor 406.

It is important to note that although the DI Code Monitor 406 is shown as one monolithic piece, it is within the true scope and spirit of the present invention to have more than one DI Code Monitor module where each separate DI Code Monitor is configured to handle a specific task.

The DI Code Monitor 406 is coupled to a DRM system interface 410 through a share memory interface. It is important to note that other types of communications method to the DRM system interface 410 is within the true scope and spirit of the invention including messages queues, APIs, semaphores, pipes and other inter-process communication techniques.

The DI Code Monitor 406 is instantiated on this client information processing system 102. In an embodiment where the OS 450 is a Windows OS and the DI Code Monitor 406 enables Windows message hooks to inject a DI Code Monitor 406 instrumentation point 404 into all currently running Windows programs (and into any applications start subsequently).

Once the DI Code Monitor 406 is injected into one or more applications 404, 454, and 464 running on the end-user machine, any messaging from the application to the OS messaging and other API calls are intercepted and monitored. The DRM system interface 410 is associated with a script of behavioral modifications preventing a user from tampering with the content via the rendering application, such as a media player or web browser. The use of OS inter-process data access mechanisms block other applications running on the client information processing system 102 that reference content data from applications rendering DRM digital content. The DI Code Monitor is quiesced while DRM content is not rendered on a client information processing system. Moreover, DRM content is only rendered to an application that has been DI Code Monitor 406 enabled.

Associating Content to a DRM system as “DRM Content”

One method to associate content with a DRM system, as “DRM content” is to use a file filter to intercept file 10 requests to files with a particular sub string in the file path, name, or extension. Any file 10 requests related to files that contain “the substring” in the filespec will be intercepted by the DRM monitor 406 that is associated with the DRM system. The file filter notifies the DRM monitor 406 when an attempt is made to open a file, with a certain “substring”, and waits for a deny or approve response. Approval occurs if the license is valid, not expired, and the application indicated by the process ID is included in a white-list. The presence in the white-list indicates that the proper configuration of the DI Code Monitor 406 is accomplished to control the set of rights supported.

All applications with a windows message queue are controlled by the present invention. If an uncontrollable application attempts to open a DRM content file it will be denied using a white list that is incorporated in the program. If the application is not in the white list the process is denied access to the file. The current list of applications is as follows.

explorer.exe

wmplayer.exe

winword.exe

acrord32.exe

In order to support applications, which do not obtain content from the file system, such as streamed videos, the combination of DI Code Monitor 406, Loader Launcher, and Application interface (such as Plug-in, or DirectX component), should provide complete DRM functionality in the absence of the file filter. An IPC (inter-process communications) mechanism provides the necessary interfaces for a plug-in to DI Code Monitor 406 enable applications.

DI Code Monitor Instrumentation Indirectly to an Application from a GDI

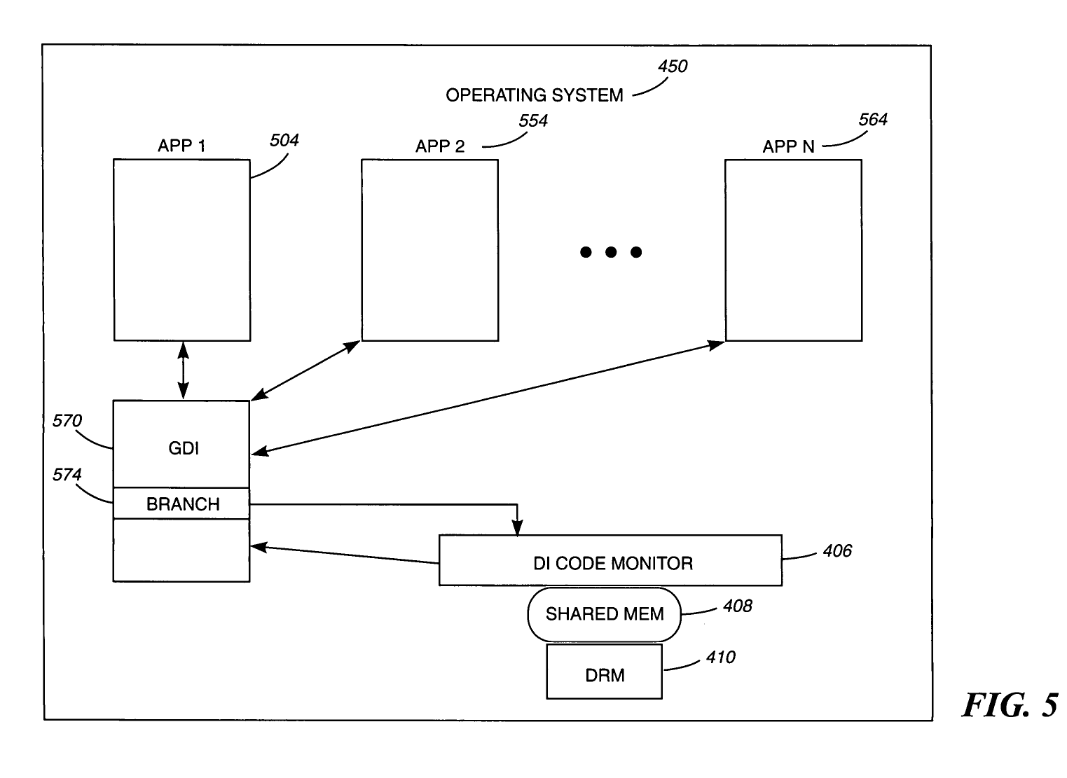

In another embodiment, FIG. 5 is a block diagram of the dynamic instrumentation code with instrumentation points and/or window hooks in a windows graphics display interface (GDI) application, according to the present invention. In this embodiment, each of the applications 504, 554, and 564 have one or more calls to a graphical subsystem such as the GDI 570. The GDI 570 is an instrumented 574 with a branch to the DI Code Monitor 406. In this embodiment, the GDI is only instrumented since it is common one or more of the applications 504, 554 and 564. It is important to note that a mix of applications which are directly instrumented (as shown in FIG. 4, or instrumented through GDI 570 as shown in FIG. 5) are within the true scope and spirit of the present invention. Moreover, a combination of instrumentation points and/or window hooks between GDI 570 and in an application 404, 454 and 464 is also contemplated in the present invention.

DI Code Monitor Instrumentation Using Windows Hook

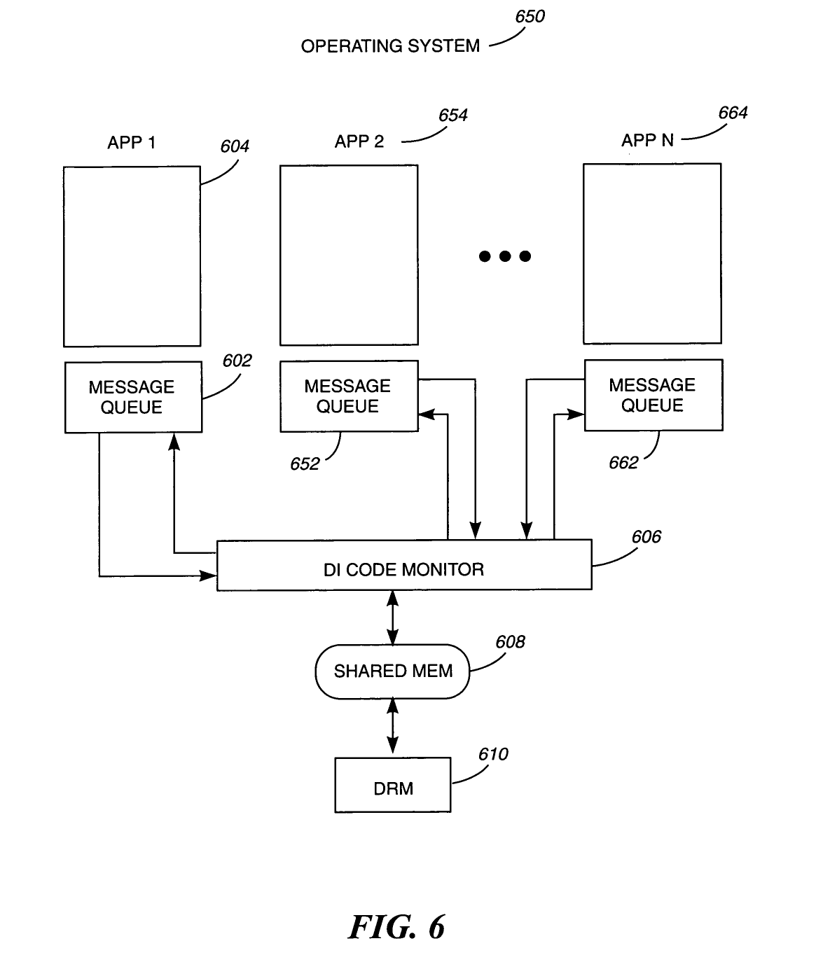

In another embodiment, the use of a “window-hooks” is executed by the Window operating system. The hook in an application (or process or DLL), in a similar fashion as the code patch embodiment described above, intercepts messages for a patched code in FIG. 5 above. For example in this embodiment, the instrumentation point 304 is a call to another process, DLL or application such as through an API (application programming interface). FIG. 6 is a block diagram of this alternate embodiment of the dynamic instrumentation code for windows messaging interception of an application, according to the present invention. Shown are a plurality of applications 604, 654, 664 running with an operating system 654. Each application has an associated message queue 602, 652, 662, which has been hooked to communicate with DI Code Monitor 606. The hook in the application, executes to intercept messages that are normally received directly by the application 604, 654, 664 through message queues 602, 652, 662. The messages are blocked or altered to change the behavior of the application. In addition, key strokes or other inter-process-communication (IPC) messages are sent to change the behavior of the application such as dismissing dialog boxes automatically to stop a user from carrying out an action such as “copying” and “pasting” from a clipboard. The DI Monitor Code Monitor 606 would control the states of the behavior for each message according to the DRM system 610.

DI Code Monitor 406 Initialization

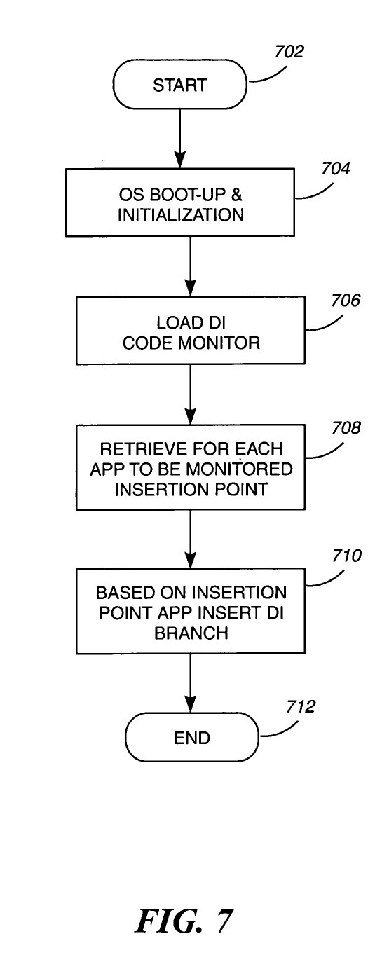

FIG. 7 is a flow diagram of an embodiment for initializing the dynamic instrumentation (DI) code monitor according to the present invention. The process begins in step 702 and immediately proceeds to step 704. In step 704 the OS initializes and boots up as usual; typically during a power-on sequence, a logon of a new user or a restart event. Once loaded, the DI Code Monitor 406 attaches itself to all processes in the current user session that posses a windows message queue. The DI Code Monitor 406 is coupled with the OS startup (e.g., registry entry). Next the DI Code Monitor 406 is loaded in step 706. For each application, 404, 454, and 464, an entry point for a branch point is determined using one of a variety of techniques described in the section entitled “IV. Dynamic Instrumentation” above. Next is step 710, based on the insertion point discerned in step 708, an instrumentation point 404, or 504 (or a plurality of instrumentation points and/or window hooks) is inserted in for each application and the initialization process completes in step 712.

In another embodiment, steps 702, 704 and 706 are already completed and when a new application is started an instrumentation point or windows hooks are added (not shown). Other hooking methods include child process debugging and registry specification injection.

It is important to note that while no digital content associated with DRM restrictions is actively being rendered on the client information processing system 102, the DI Code Monitor 406 is quiescent (providing null intervention between applications and the OS except for monitoring).

DI Code Monitor 406 Communication with DRM Interface

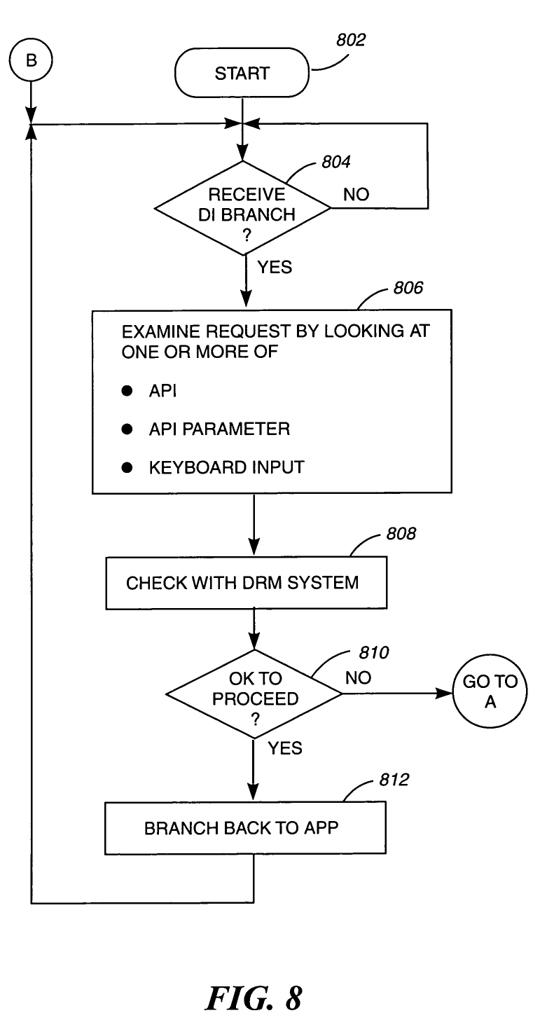

FIGS. 8 and 9 is a flow of an embodiment of the dynamic instrumentation (DI) code monitor for handling branches from an application being dynamically instrumented in FIGS. 4 and 5. The process begins with step 802 and proceeds immediately to step 804 to determine if a DI branch is received. If a DI branch is not received, the process loops in a quiescent state. Once a branch is received in step 804 from an application 404, 454, and 464, the process continues to step 806 where the DI Code Monitor 406 handles the branch. In one embodiment, the branch simply stops the request from the application 404, 454, and 464. In another embodiment, the DI Code Monitor 406, in step 806 examines one or more of an API, an API parameter, mouse, and a keyboard input. Next a check of the DRM system state, in step 808, is made with the DRM system interface 410. In one embodiment, all the DRM settings for a particular associated player and its content is already loaded in shared memory 408 when the digital content is given to an application. In another embodiment a query is made to the DRM system interface 410. The mechanisms for associating DRM rights with digital content is not important to the present invention. A variety of methods are possible, such as the methods explained in detail in co-pending U.S. patent application Ser. No. 09/938,401 filed Aug. 23, 2001 now [pending], for “Method and System of Preventing Unauthorized Rerecording of Multimedia Content” with inventors Michael G. Liskanke et al, which is commonly assigned herewith to International Business Machines. The above aforementioned patent application is incorporated hereinto in its entirety by reference. Other mechanisms for associating content with DRM systems are available from AT&T, Liquid Audio Pro Corp., Audio Soft, InterTrust, ContentGuard, EMediator, from MediaDNA, Vyou.com and many others. One distinct advantage of the present invention is that it is not tied to a specific DRM system.

If the process is not a windows application, then the DI Code Monitor 406 will indicate the process is not authorized for the content, and any file open attempt will be denied. The DI Code Monitor 406 modifies the applications menu and hot key selections based on the particular content access rights. The DI Code Monitor 406 only modifies the menu of those processes accessing DRM content, although it will appear in the address space of all loaded processes. The DI Code Monitor 406 also signals the loader launcher when the user attempts a previously specified action. This signal results in an audit record being sent to the servers (if enabled) and a notification dialog being presented to the user if the action was blocked. The following dialogs are examples.

Next in step 810, depending on the authorization for the DRM system interface 410, a decision is made whether or not permission has been granted to proceed. If permission has been granted or licensed, then in the simplest case the flow returns to application being instrumented in step 812, and the DI code monitor 406 returns to a quiescent state. In the event in step 810, the DRM system interface 410 instructs the DI Code Monitor 406 that it is not authorized to proceed, the process continues on step 914.

In step 914, the action of the content associated with a DRM system is blocked by one or more of the following methods:

blocking an API

blocking a parameter of an API

substituting a parameter for an API

dismissing a menu item

ignoring keyboard Input

terminating the process

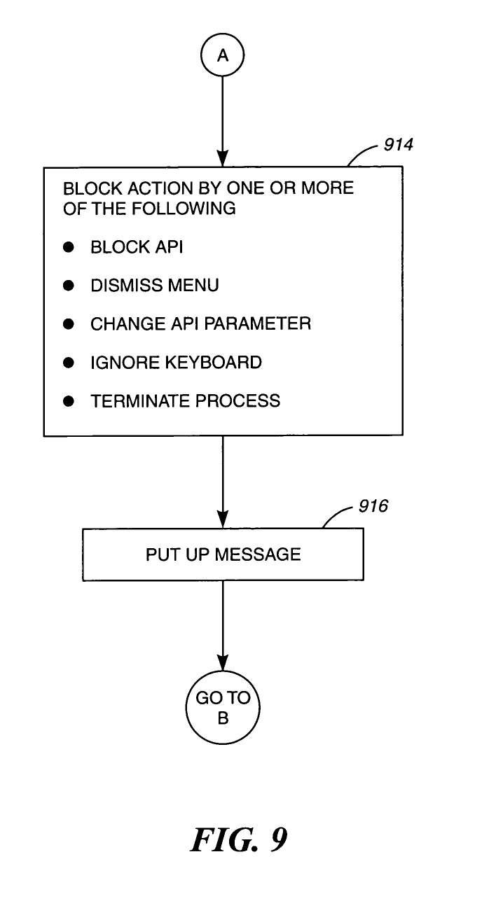

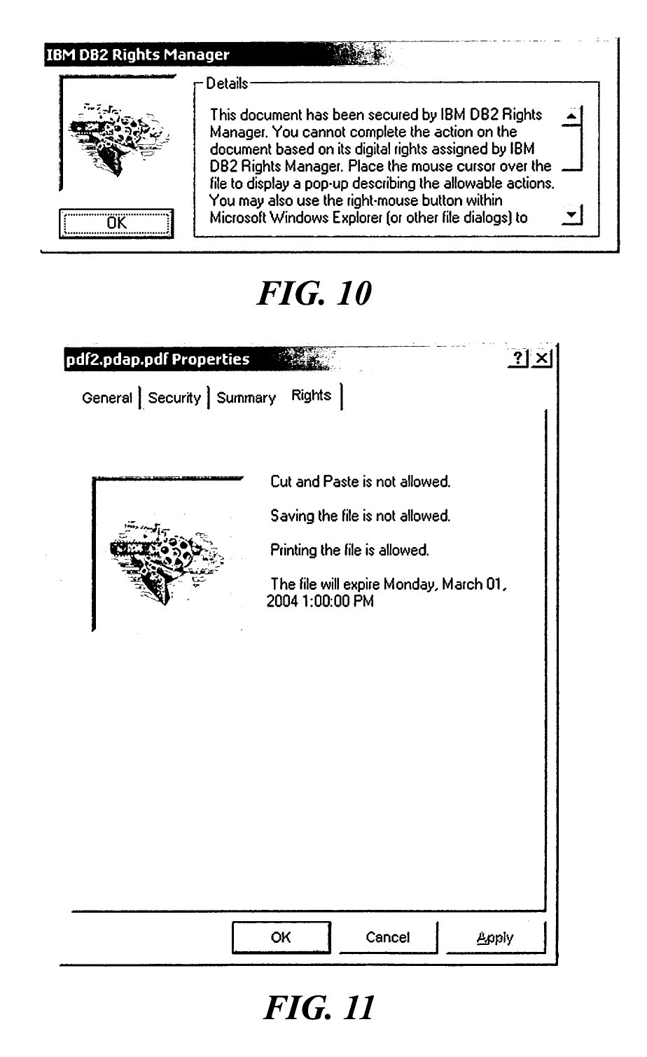

In step 916, an optional message is signaled to be posted, such as through IPC (as shown in FIG. 10) and the process returns to the quiescent state in step 804. FIG. 10 is a dialog box notifying a user that their attempted action or behavior exceeds the rights in the content, according to the present invention. FIG. 11 is a dialog box showing an optional property of a DRM content file according to the present invention.

In step 914, when the DI Code Monitor 406 detects applications branch to access DRM content, the digital rights of content will be read and assessed, and from this the behavioral modifications required to enforce the contents rights will be scripted. In another embodiment, a white-list of behavioral modifications is preconstructed for the required rights. The behavioral modifications required to enforce the digital rights of the content will be made at the point where the DI Code Monitor 406 detects the use (by the computer user), and the client “player” application DRM proscribed functions (we call this process DI Code Monitor 406) is enabled.

In the embodiment of FIG. 5 where the GDI is instruments, such as GDI API (application programming interface) e.g. BitBit( ), is monitored and their operation is selectively failed if an access to a DI Code Monitor 406 enabled applications' data is referenced. After the DRM content has been closed (no longer rendered “in-the-clear”), the DI Code Monitor 406 will again quiescence.

A systematic example illustrates the above invention embodiment mechanisms. For this example, we assume that a user intends to violate the digital rights assigned to the content they have licensed and have loaded on their end-user computer. Also we assume this content is an Adobe portable document format (pdf file) to be rendered by the Adobe Acrobat Reader application. The user, in order to license the content, must have installed the DI Code Monitor 406 on their end-user computer. In addition, a DRM client enabler does not render content “in-the-clear” without the active presence of the DI Code Monitor 406 on the end-user computer. In this example, the user launches Acrobat Reader, and prepares to use its menu functions to “Save”, “Print”, “Cut/Copy/Select”, etc, the content that has been rendered. Because this application has been DI Code Monitor 406 enabled, these menu functions (and their associated accelerator keys) are disabled. Assuming a sophisticated user, we assume that they will start (or have running) an application that can request the OS to copy data that was rendered to the Acrobat application's GDI objects (including all of its visually rendered data). Since all applications on the DI Code Monitor 406 enabled system are monitored for access to API that can access inter-process data, which API calls “refer to DRM rendering applications' data”, these accesses are blocked. Short of directly engineering an attack on the DRM client software (including the DI Code Monitor 406 function), all client software attempts to access the DRM content in violation of its digital rights are thwarted. For completeness and not important to the understanding of the present invention, typically additional software tamper resistance (S-TR) is included with the DRM client to prevent this attack.

In another embodiment, the process of watching behavior between processes for DRM monitoring is performed. For example, if a user has an audio port already open for DRM content, such as writing a copy to a computer readable medium, and the user attempts to open a second audio port, the DI Code Monitor 406 puts up a message that states the user is not licensed to have two audio ports open simultaneously.

In addition to installing this DRM Code Monitor 406 functionality as described above, the optional following are also accomplished.

Access Controls

The following is a non-exhaustive list of the types of access controls supported.

Print (Yes/No)

Cut/Paste (Yes/No)

Fixed or sliding Interval expressed as an expiration date

Save and SaveAs encrypted (Yes/No)

SaveAs unencrypted (Yes/No)

Auditable Events

The following lists examples of auditable events. Each auditable event is not individually selectable. The license from each transaction will turn all auditing on or off and affect all subsequent behavior of the client.

Each Print

Each Cut/Paste

Each File Open or Close

Each attempted download regardless of success

Each expiration event as encountered

Each Save or Save as

The present invention, according to a preferred embodiment, overcomes problems with the prior art by providing an efficient and easy-to-implement method to use existing DRM (Digital Rights Management) systems with existing media players.

DRM System Interface

The DRM System Interface 410 is used to provide applications with conditional access to controlled files. These files are encrypted and can only be decrypted if the access criteria are met. This DRM system, in one embodiment, provides a file filter such that granted access to the encrypted files appears to behave as though the files are unencrypted. The content is further protected, once unencrypted, by surreptitiously configuring the application menu selections to deny behavior contrary to the restrictions applied to the secured files. These functions are achieved through means provided by the OS and do not require build time modifications to the rendering applications.

DI Code Monitor APIs

The loader launcher coordinates the activities of the DI Code Monitor 406 and File Filter relative to the DRM associated digital content. The loader launcher interfaces with the DI Code Monitor 406 through the use of the following APIs. The DI Code Monitor 406 initiates communications through an event that blocks on:

BOOL Hook(HWND hwnd); // Enables the BTR Window Hooks to allow code injection

BOOL Unhook( ); // Disables API patches and Window hooks

BOOL GetMonMsg(tMsgMon *pMsgMon); // Retrieves queued monitor messages (diagnostics)

tMonitor const *GetMonitor(UINT nMonitor); // Retrieves monitor specification

UINT SetMonitor(int iType, DWORD dwData, DWORD dwMask, DWORD dwFilters); // Specifies a window message monitor

BOOL IsProcessHooked(DWORD dwXPID); // tests if an application is BTR enabled

BOOL EnableDebug(UINT nDebug); // enables/disables diagnostic tracing (spec's which traces)

BOOL WaitAllUnhooked( ); // waits for all unhooking (quality assurance)

BOOL GetLastMousePoint(POINT *pPt); // diagnostic

UINT AddBlock(UINT nMonitor, DWORD dwFlags, DWORD dwFilters, HWND hwnd, UINT message, WPARAM wParam, LPARAM lParam, DWORD dwDR); // specifies that a particular message be blocked

BOOL SetBlockActive(UINT nBlock, BOOL bActive); // toggles activation of a message block

UINT GetFirstBlock(UINT nMonitor); // retrieves first message block ID of a message monitor

UINT GetNextBlock(UINT nBlock); // retrieves subsequent message block IDs (chained)

tBlock const *GetBlock(UINT nBlock); // retrieves message block specification

UINT AddTrigger(UINT nMonitor, DWORD dwFlags, DWORD dwFilters, HWND hwnd, UINT message, WPARAM wParam, LPARAM lParam, UINT nMsgCap); // adds a message trigger (to monitor a preset number of messages after trigger)

BOOL SetTriggerMsgCap(UINT nTrigger, UINT nMsgCap); // select number messages to capture

UINT GetFirstTrigger(UINT nMonitor); // retrieves first trigger ID of a message monitor

UINT GetNextTrigger(UINT nTrigger); // retrieves subsequent trigger IDs (chained)

tTrigger const *GetTrigger(UINT nTrigger); // retrieves message trigger specification

BOOL SetDebugHook(DWORD dwPID, UINT nDbgHook); // hooks debug hook (diagnostics)

BOOL SetClipboardBlock(DWORD dwPID, BOOL bBlock); // enables serial enqueue of desktop.

BOOL IsClipboardBlocked(DWORD dwPID); // test clipboard block spec. of an application

UINT AddWindowBlock(DWORD dwPID, DWORD dwDR, char const *pszTitle); // enables window block (by title) of window activation (dismisses)

BOOL DeleteWindowBlock(DWORD dwPID, char const *pszTitle); // removes window block for application

UINT GetWindowBlock(DWORD dwPID, UINT nFromBW); //—retrieves window block ID for application (nFromBW=0 first, non-0 nexted)

char const *GetWindowBlockTitle(UINT nGBW); // retrieves specification of window block ID (title)

HANDLE GetDREventHandle( ); // retrieves handle digital-right event signal

DWORD WaitForDREvent(DWORD dwTimeout); // waits for a digital-right event to queue

tDREvent const *GetDREvent( ); // retrieves queued digital-right event

BOOL SetApiBlock(DWORD dwPID, DWORD dwAddr, DWORD dwParms, DWORD dwFailRC, DWORD dwDR); // specifies an API block for spec'd application:address

BOOL DeleteApiBlock(DWORD dwPID, DWORD dwAddr); // removes an API block from application:address

BOOL IsApiBlocked(DWORD dwPID, DWORD dwAddr); // test is application:address is blocked

Embodiment for Safe Data Handling

In this embodiment, the DI Code Monitor 406, instead of watching DRM content, watches certain files that are opened for data handling, such as documents used in word processing or spreadsheets, or any other authoring tool environment where the loss of intermediate data is possible. In the event of a authoring program hanging or not responding, the DI Code Monitor 406 puts up a message to a user asking if they wish to close all file handles & close buffers. This keeps data from being lost, even though the operating system and/or the authoring application program has failed to close certain buffers and handles.

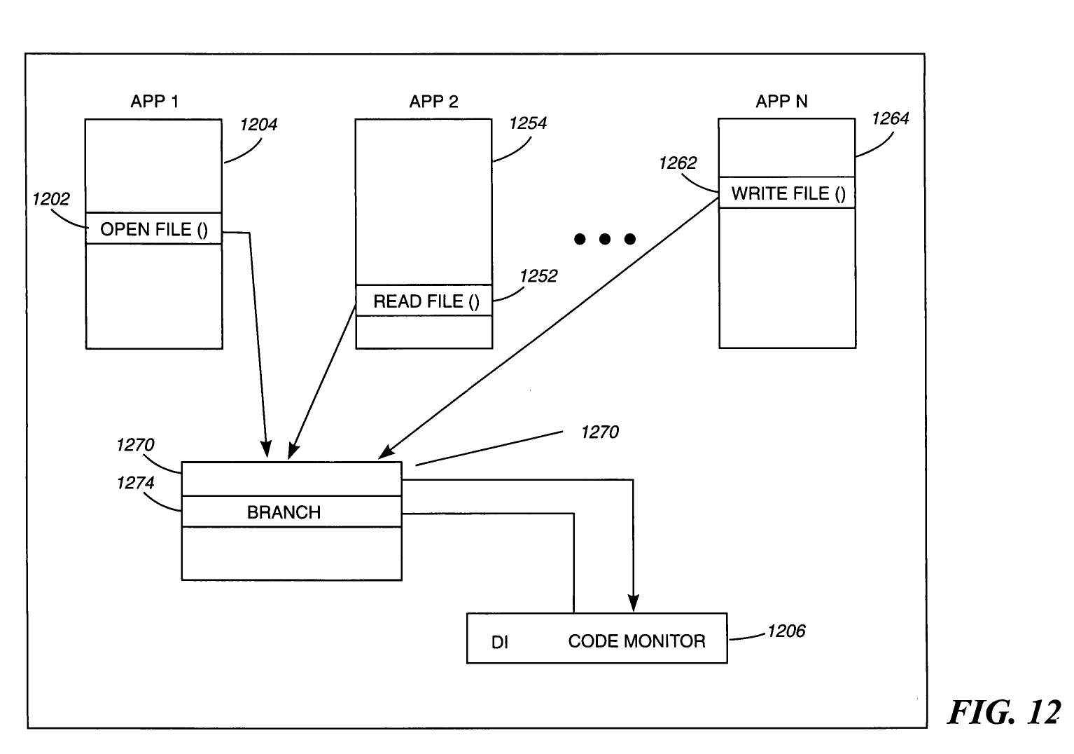

Turning to FIG. 12, shown is a block diagram of the dynamic instrumentation code with instrumentation points and/or windows hooks for file monitoring, according to the present invention. In this embodiment, each of the applications 1204, 1254, and 1264 have one or more calls to a Kernel32.dll 1270, that is the Windows OS kernel interface dynamic-link-library (DLL). More specifically, in this embodiment, one or more of the applications 1204, 1254, and 1264 are content authoring applications with API calls for file-system access such as “OpenFile ( )” 1202, “ReadFile ( )” 1252, and “WriteFile ( )” 1262, Kernel32.dll 1270 contains the “OpenFile ( )” 1202, “ReadFile ( )” 1252, and “WriteFile ( )” 1262 APIs. These APIs, and others, are file-system access interfaces provided by the Windows kernel. The Kernel32.dll 1270 is instrumented 1274 with a branch to the DI Code Monitor 1206. In this embodiment,

The instrumentation point for an application occurs in its process virtual memory (and no other). All code instrumentation must be done on a per process basis (each application shown, here in FIG. 12, but; also in all other diagrams showing code patches, are distinct processes with their own virtual memory space). Patching code in Kernel32.dll to instantiate the DI code monitor is done repeatedly for all processes that need file system APIs monitored. The Kernel32.dll 1270 is instrumented for each of the applications 1204, 1254 and 1264

It is important to note that a mix of applications which are directly instrumented (as shown in FIG. 4, or instrumented through GDI 570 as shown in FIG. 5, or instrumented through Kernel32.dll 1270 as shown in FIG. 12) are within the true scope and spirit of the present invention. Moreover, a combination of instrumentation points and/or window hooks between Kernel32.dll 1270 and in an application 1204, 1254 and 1264 is also contemplated in the present invention. The DI code monitor 1206 in this embodiment watches to determine if a file is accessed by one or more of the applications 1204, 1254, and 1264 are not closed properly. If the file is not closed properly, the user is prompted to ask whether the file handles and buffers left open by the applications 1204, 1254, and 1264 should be closed and closes them accordingly.

Embodiment for Virus Blocker

In this embodiment, the DI Code Monitor 406, instead of watching DRM content, watches certain files that are prone to virus attacks, such as the Microsoft Outlook Address Book. In this embodiment, each message that was sent using the Outlook Address Book must be given permission to access the address book. This keeps popular variants of viruses such as “Lisa” or the “I Love You” viruses from surreptitiously gaining access to certain files that are being tracked by the DI code monitor 406 without explicit permission. Unlike traditional virus blockers, this method does not have to rely on constant updates to “virus signature files” to be very effective in minimizing the destructive nature of mass mailing viruses.

In this embodiment as described above for “Embodiment for Safe Data Handling”, each of the applications 1204, 1254, and 1264 have one or more calls to a low level address book process (not shown). The address book process is only instrumented since it is one or more of the applications 1204, 1254 and 1264. Moreover, a combination of instrumentation points and/or window hooks between Kernel32.dll 1270 and in an application 1204, 1254 and 1264 is also contemplated in the present invention. The DI code monitor 1206 in this embodiment watches to determine if a request made to the address book has been previously authorized. This authorization may be in the form of a “white list” of authorized applications or other methods described above for associating the DI Code Monitor with an application. If the application, in this exemplary a virus, is not authorized to use the address book, the request is blocked accordingly.

Embodiment of Application Interface Extension(s)

In this embodiment, the DI code monitor, installs patches to the standard functions used by an application to allow a user to select the input file to be read, or the output file to be written with updates, extending these functions to allow the end-user to select a server stored file. When the use of these functions, is detected by the DI code monitor, the monitor provides an alternate user dialog, which in addition to allowing the end-user the selection of local files (or those already accessible through mapped network interfaces), also allows the end-user to select files interfaces via client-server software, added to the application, that are accessible from a server.

### CONCLUSION

It is important to note to those of average skill in the art, that the present invention modifies behaviors of existing applications. With this in mind, the present invention provides a mechanism to add new functionality, features and in some cases even new products to existing third party applications without the need to access source code or receive permissions to alter the applications from the application owner. This is especially important in applications where support has been withdrawn, such as old versions of applications, where the addition of new functions and features is desirable.

Although specific embodiments of the invention have been disclosed, those having ordinary skill in the art will understand that changes are made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for enforcing digital rights management to digital content on a client information processing system, the method comprising:
loading at least one dynamic instrumentation (DI) codemonitor;
loading at least one digital rights management (DRM) system for enforcing rights on at least one piece of digital content;
retrieving at least one entry point for at least one application to insert at least one instrumentation point thereinto; and
inserting at least one instrumentation point into the application in accordance with the entry point, wherein the instrumentation point causes a branch into the DI code monitor when executed;
wherein depending on the application with the instrumentation point therein, the DI code monitor modifies a request made by the application code.

2. The method according to claim 1, wherein the DI code monitor intercepts a request made by the application;
wherein the DI code monitor checks a state with the DRM system for permission to execute the request; and
wherein if the DRM system indicates permission to execute the request, the DI code monitor returns control back to the application.

3. The method according to claim 1, wherein if the DRM system denies permission to execute the request, the DI code monitor blocks the application from carrying out the request.

4. The method according to claim 1, wherein if the DRM system denies permission to execute the request, the DI code monitor blocks the application from carrying out the request by at least one of the following:
dismissing a menu item in the application;
changing a parameter in an API in the application;
blocking subsequent keyboard input; and
blocking subsequent mouse input;

5. The method according to claim 2, wherein the request by the application is examined by performing at least one of.
determining if another port is open; and
determining if keyboard input;

6. The method according to claim 1, wherein the application is an application without available DRM support.

7. The method according to claim 6, wherein the provider of the application and the provider of the DRM system are different business entities.

8. The method according to claim 1, wherein the application is an application with available DRM support.

9. The method according to claim 1, wherein the inserting at least one instrumentation point includes hooking a message queue associated with the application.

10. A method for enforcing behavior restrictions on an application on an information processing system, the method comprising:
loading at least one dynamic instrumentation (DI) code monitor;
retrieving at least one entry point for at least one application to insert at least one instrumentation point thereinto; and
inserting at least one instrumentation point into the application in accordance with the entry point, wherein the instrumentation point causes a branch into the DI code monitor when executed;
wherein depending on the application with the instrumentation point therein, the DI code monitor modifies a request made by the application code.

11. The method according to claim 10, wherein the application is a operating system process associated with an e-mail program address book.

12. The method according to claim 10, wherein the application is a Kernel32.dll being accessed an authoring program and the modifying a request made by the application code is blocking request to close files until closing files handles and buffers associated with the files opened are written.

13. The method according to claim 11, wherein the user of the application is prompted to determine if the file handles and buffers associated with the application are closed.

14. A computer readable program medium containing programming instructions for enforcing digital rights management to digital content on a client information processing system, the programming instructions comprising:
loading at least one dynamic instrumentation (DI) code monitor;
loading at least one digital rights management (DRM) system for enforcing rights on at least one piece of digital content;
retrieving at least one entry point for at least one application to insert at least one instrumentation point thereinto; and
inserting at least one instrumentation point into the application in accordance with the entry point, wherein the instrumentation point causes a branch into the DI code monitor when executed;
wherein depending on the application with the instrumentation point therein, the DI code monitor modifies a request made by the application code.

15. The computer readable program medium according to claim 14, wherein
the DI code monitor intercepts a request made by the application;
the DI code monitor checks a state with the DRM system for permission to execute the request; and
wherein if the DRM system indicates permission to execute the request, the DI code monitor returns control back to the application.

16. The computer readable program medium according to claim 14, wherein if the DRM system denies permission to execute the request, the DI code monitor blocks the application from carrying out the request.

17. The computer readable program medium according to claim 14, wherein if the DRM system denies permission to execute the request, the DI code monitor blocks the application from carrying out the request by at least one of the following:
dismissing a menu item in the application;
changing a parameter in an API in the application;
blocking subsequent keyboard input; and
blocking subsequent mouse input;

18. The computer readable program medium according to claim 15, wherein the request by the application is examined by performing at least one of.
determining if another port is open; and
determining if keyboard input;

19. The computer readable program medium according to claim 14, wherein the application is an application without available DRM support.

20. The computer readable program medium according to claim 19, wherein the provider of the application and the provider of the DRM system are different business entities.

21. The computer readable program medium according to claim 14, wherein the application is an application with available DRM support.

22. The computer readable program medium according to claim 14, wherein the inserting at least one instrumentation point includes hooking a message queue associated with the application.

23. A client information processing system comprising:
at least one application;
at least one dynamic instrumentation (DI) code monitor;
at least one digital rights management (DRM) system for enforcing rights on at least one piece of digital content; and
at least one entry point for the application to insert at least one instrumentation point thereinto, wherein instrumentation point causes a branch into the DI code monitor when executed;
wherein depending on the application with the instrumentation point therein, the DI code monitor modifies a request made by the application code.

24. The client information processing system to claim 24, wherein the DI code monitor intercepts a request made by the application;
wherein the DI code monitor checks a state with the DRM system for permission to execute the request; and
wherein if the DRM system indicates permission to execute the request, the DI code monitor returns control back to the application.

25. The client information processing system according to claim 24, wherein if the DRM system denies permission to execute the request, the DI code monitor blocks the application from carrying out the request.
